(19) United States
(12) Patent Application Publication
(10) Pub. No.: US 2021/0031438 A1
(43) Pub. Date: Feb. 4, 2021

(54) MULTIMATERIAL FABRICATION FOR DIGITAL LIGHT PROCESSING BASED 3D PRINTING AND SYSTEMS THEREFOR

(71) Applicant: Singapore University Of Technology And Design, Singapore (SG)

(72) Inventors: Qi GE, SINGAPORE (SG); Biao ZHANG, SINGAPORE (SG); Martin DUNN, SINGAPORE (SG); Kavin KOWSARI, SINGAPORE (SG)

(21) Appl. No.: 16/982,247

(22) PCT Filed: Mar. 21, 2019
(86) PCT No.: PCT/SG2019/050150

§ 371 Date: Sep. 18, 2020

(30) Foreign Application Priority Data
Mar. 21, 2018 (SG) 10201802321Q
Apr. 4, 2018 (SG) 10201802825W

(51) Int. Cl. B29C 64/124; B29C 64/232; B29C 64/35; B29C 64/245; B29C 64/264; B29C 64/205; B29C 64/188; B29C 64/393

(52) U.S. Cl. CPC B29C 64/124; B29C 64/232; B29C 64/35; B29C 64/245; B33Y 10/00; B29C 64/205; B29C 64/188; B29C 64/393; B29C 64/264

(57) ABSTRACT

System and methods for three-dimensional printing are provided. In accordance with one aspect, a method for multimaterial fabrication of three-dimensional (3D) printed structures includes lifting a printing platform having a 3D printed structure formed thereon to remove the 3D printed structure from a plate through which radiation was transmitted to fabricate the 3D printed structure and activating a blast of an air jet focused on the surface of the plate under the printing platform to remove waste material left on the surface of the plate when the printing platform is lifted. In accordance with another aspect, method for three-dimensional (3D) printing includes photopolymerizing a photocurable resin to form a fabricated structure and programmed thermal treating of the fabricated structure for transesterification of material of the fabricated structure.

### PRIORITY CLAIM

This application claims priority from Singapore Patent Application No. 10201802321Q filed on 21 Mar. 2018 and Singapore Patent Application No. 10201802825W filed on 4 Apr. 2018.

### TECHNICAL FIELD

The present invention generally relates to three-dimensional (3D) printing, and more particularly relates to digital light processing 3D printing systems capable of fabricating components made of multiple materials including reprocessable thermosets in a quick and fully-automated manner.

### BACKGROUND OF THE DISCLOSURE

Three-dimensional (3D) printing is an additive manufacturing process which is providing new capabilities to fabricate highly detailed, complex 3D micro-architectures composed of a wide range of materials and has become a powerful technique enabling a wide variety of applications, including tissue engineering, soft robotics, nano-devices, optical engineering, and metamaterials. One of the unique capabilities of 3D printing is the fabrication of multimaterial components in a single build process, which can vastly broaden the applications offering multiple mechanical, electrical, chemical or biological properties not otherwise possible using single-material systems.

Fabricated lightweight lattice structures have been demonstrated that exhibit tunable negative thermal expansion in three directions with the aid of multimaterial fabrication techniques. Such multimaterial fabrication can be realized in fused deposition modeling (FDM) and direct-ink writing (DIW) by simply adding extra printing nozzles to deposit different materials. These multimaterial 3D printing methods have been successfully applied to fabricate biomaterials and tissue scaffolds.

However, the manner of printing 3D structures using an extrusion nozzle constrains the geometric complexity to 2.5 dimensions or to simple 3D structures, and the hundreds micrometer scale of the printing nozzles limits the printing resolution. Multimaterial 3D printing has also been successfully realized in Polyjet 3D printing technology in which photocurable resin is jetted over a surface through micro-nozzles followed by curing with ultraviolet (UV) light. However, the finest edge definition attainable using Polyjet 3D printers is about 200 μm in a lateral direction and is limited by a minimum nozzle size that can only effectively deposit relatively viscous liquids or particle-laden slurries. Therefore, the Polyjet 3D printing process is difficult downscale. Another drawback is that the choice of materials is limited to those supplied by the manufacturer which limits the potential flexibility in material choice or process customization. Lastly, the Polyjet 3D printing methodology necessitates the use of support materials and the process of removing the support materials after printing is time-consuming, and raises the possibility of damaging the printed parts.

So, compared to the other 3D printing technologies, digital light processing (DLP) based 3D printing is a low-cost, fast-speed, and high-resolution 3D printing technology which is based on a localized photo-polymerization process triggered by the projection of digitally masked UV patterns onto a liquid surface. Since the printing process takes place in a liquid environment, DLP-based 3D printing eliminates the requirement for the use of any support materials in the fabrication of porous or hollow structures and has therefore been used to fabricate lattice metamaterials, pneumatically actuated soft robots, and many other structures and devices constructed with trusses or cavities. In recent years, notable advances in DLP-based 3D printing technologies include projection micro-stereolithography that can produce micron-scale printing resolution, continuous liquid interface production enabling 100 times faster printing, and large area projection micro-stereolithography producing 3D features having feature sizes over seven orders of magnitude from nanometers to centimeters. While fabricated lightweight lattice structures have been demonstrated in one study that exhibit tunable negative thermal expansion in three directions with the aid of multimaterial projection micro-stereolithography, most studies focus on single-material fabrication. Thus, the development of multimaterial DLP based 3D printing systems using techniques such as multimaterial projection micro-stereolithography remain comparatively limited.

One studied demonstrated top-down exposure DLP with multiple resin containers in an attempt to reduce the fabrication time, but the use of cleaning solutions to remove uncured resin proved to be damaging to features finer than approximately 300 μm. In addition, it was found that controlling the liquid levels in the multiple containers was difficult and the process was still relatively slow in the fabrication of complex multimaterial parts.

Another study demonstrated multimaterial printing using a top-down exposure DLP system in which a digitally-masked UV pattern was directed downward onto the surface of a resin-filled container to fabricate parts having an edge resolution accurate to about 30 μm. However, the material exchange process required draining and refilling of resin within the vat, thereby significantly slowing the process.

In addition to top-down exposure approaches, a multimaterial 3D printing system based on a bottom-up exposure method using a rotating wheel having containers with different material to realize the material exchange has been reported. However, the cleaning process for this exposure approach involved a brushing process along with ultrasonication which significantly slowed the process. Instead of placing the material containers on a rotating wheel, another bottom-up exposure based multimaterial 3D printing approach used a rotating wheel to deliver different material droplets which were selectively deposited onto the wheel. The system was used to successfully fabricate metamaterial structures with negative thermal expansion coefficients, however the complex material exchange process elongated the fabrication time of a structure of approximately 6 mm long, 6 mm wide and 6 mm high to over six hours, and severe material contamination was observed in the printed structures.

Thus, it remains a challenge to realize multimaterial 3D printing using conventional technologies. DIW and FDM methods are limited to in sub-millimeter printing resolution as well as the geometrical complexity of the printed structures. Polyjet methods are unable to fabricate features smaller than about 200 μm and require the use of support materials. Also, while DLP based 3D printing can ensure high printing resolution, conventional material exchange mechanisms make DLP based multimaterial 3D printing systems time-consuming and inefficient in material usage.

As to materials, compatibility with ultra-violet (UV) curing-based 3D printing makes thermosetting photopolymers ideal for printing high-resolution structures at micro-scales, submicro-scales, and even nano-scales. In fact, due to their superior mechanical stability at high temperatures, excellent chemical resistance and good compatibility with high-resolution 3D printing technologies, thermosetting photopolymers now claim almost half of the 3D printing materials market.

However, once traditional thermosetting photopolymers form 3D parts through photopolymerization, the covalent networks are permanent and cannot be reprocessed, reshaped, repaired, or recycled as the polymer networks are covalent crosslinked. This unprocessable nature, combined with the explosion in 3D printing globally is leading to a vast waste of 3D printing materials with serious environmental implications. Recent advances in the development of dynamic covalent bond (DCB) materials that exploit the reformation and rearrangement of crosslinked networks to enable reprocessability including self-healing, remolding, and welding offer a possibility of making thermoset printing materials reprocessable. While an example of recyclable 3D printing with a DCB based epoxy has been reported, the complicated preparation procedure used constrained the material to direct-ink-writing (DIW) 3D printing technology, thereby limiting both the printing resolution as well as the product geometric complexity.

Thus, there is a need in the art for a novel material exchange mechanism for building a high-efficiency, high-resolution DLP based multimaterial 3D printing system. Also, there is a need for reprocessable, recyclable thermoset printing materials compatible with various 3D printing technologies. Furthermore, other desirable features and characteristics will become apparent from the subsequent detailed description and the appended claims, taken in conjunction with the accompanying drawings and this background of the disclosure.

### SUMMARY

According to at least one aspect of the present embodiments, a method for multimaterial fabrication of three-dimensional (3D) printed structures is provided. The method includes lifting a printing platform having a 3D printed structure formed thereon to remove the 3D printed structure from a plate through which radiation was transmitted to fabricate the 3D printed structure and activating a blast of an air jet focused on the surface of the plate under the printing platform to remove waste material left on the surface of the plate when the printing platform is lifted.

According to another aspect of the present embodiments, a system for multimaterial fabrication of three-dimensional (3D) printed structures is provided. The system includes a printing platform, a UV-transparent plate and an air jet. Radiation is transmitted through the UV-transparent plate to fabricate the 3D printed structure on the printing platform. The air jet is focused on a surface of the plate under the printing platform to use a blast of air to remove waste material left on the surface of the plate when the printing platform with the 3D printed structure attached is lifted a predetermined distance above the surface of the UV-transparent plate.

And according to a further aspect of the present embodiments, a method for three-dimensional (3D) printing is provided. The method includes photopolymerizing a photocurable resin to form a fabricated structure and programmed thermal treating of the fabricated structure for transesterification of material of the fabricated structure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1, comprising FIGS. 1A and 1B, depicts illustrations of a digital light processing (DLP) three-dimensional (3D) printing system in accordance with a present embodiment, wherein FIG. 1A depicts a schematic illustration of the DLP 3D printing system and FIG. 1B depicts a photographic illustration of the DLP 3D printing system.

FIG. 2, comprising FIGS. 2A to 2D, depicts steps in a DLP 3D printing process for multi material fabrication in accordance with a present embodiment, wherein FIG. 2A depicts a layer formation step for a first material, FIG. 2B depicts an air jet cleaning and puddle refilling step following the step depicted in FIG. 2A, FIG. 2C depicts a layer formation step for a second material, and FIG. 2D depicts an air jet cleaning and puddle refilling step following the step depicted in FIG. 2C.

FIG. 3, comprising FIGS. 3A to 3D, depicts characterization of ultraviolet (UV) patterns projected by a DLP light engine in the DLP 3D printing system of FIGS. 1A and 1B in accordance with the present embodiments, wherein FIG. 3A depicts test pattern inputs to the DLP 3D printing system and sensor captured patterns at a focus plane of the DLP 3D printing system, FIG. 3B depicts a UV pattern projected by the DLP light engine for printing a layer, FIG. 3C depicts a top planar microscope image of the printed layer on a glass plate, and FIG. 3D is a graph depicting normalized gray value versus distance along line A-A′ in FIG. 3B.

FIG. 4, comprising FIGS. 4A to 4C, depicts characterization of printing resolution of the DLP 3D printing system of FIGS. 1A and 1B in accordance with the present embodiments, wherein FIG. 4A depicts a cross-sectional schematic illustration of an edge slope formed in a bottom-exposure printing configuration of the DLP 3D printing system, FIG. 4B depicts a graph of width and height versus exposure time for a projected UV pattern for formation of a two-material structure, and FIG. 4C depicts a surface topography illustration of a one second exposure for one material layer in the formation of the two-material structure of FIG. 4B.

FIG. 5, comprising FIGS. 5A and 5B, depicts schematic illustrations of steps in the formation of a sacrificial layer used to initiate the DLP 3D printing process for multi material fabrication in accordance with present embodiments, wherein FIG. 5A depicts a first step and FIG. 5B depicts a subsequent second step.

FIG. 6, comprising FIGS. 6A to 6D, depicts substrates printed using the DLP 3D printing systems and methods in accordance with present embodiments, wherein FIG. 6A depicts a high-resolution illustration of a two-material structure on top of a single material structure, FIG. 6B depicts a single material structure fabricated, FIG. 6C depicts a first two-material structure, and FIG. 6D depicts a second two-material structure.

FIG. 7, comprising FIGS. 7A and 7F, depicts multimaterial fabrication capability and performance of the DLP 3D printing systems and methods in accordance with present embodiments, wherein FIG. 7A depicts first multimaterial structures using a first material and a second material, FIG. 7B depicts second multimaterial structures using the first material and the second material, FIG. 7C depicts third multimaterial structures using the first material and the second material, FIG. 7D depicts fourth multimaterial structures using the first material and the second material, FIG. 7E depicts fifth multimaterial structures using the first material and a third material, and FIG. 7F depicts a highly magnified view of a sixth multimaterial structure using the first material and the second material.

FIG. 8, comprising FIGS. 8A and 8B, depicts bright-field photographic images of a liquid resin puddle at different steps in the DLP 3D printing process for multimaterial fabrication in accordance with present embodiments, wherein FIG. 8A depicts a photographic image before printing and FIG. 8B depicts a photographic image after printing.

FIG. 9 depicts a bar graph comparing printing speed of a lattice structure layer made of two materials between the DLP 3D printing system of FIGS. 1A and 1B in accordance with the present embodiments and other 3D printing systems.

FIG. 10, comprising FIGS. 10A to 10D, depicts images and a graph of characterization of bond strength between different materials fabricated by the DLP 3D printing systems and methods in accordance with present embodiments, wherein FIG. 10A depicts a photographic image of a tensile specimen made of a first material before and after a uniaxial tensile test, FIG. 10B depicts a photographic image of a tensile specimen made of a second material before and after a uniaxial tensile test, FIG. 100 depicts a photographic image of a multimaterial tensile specimen made of both the first material and the second material before and after a uniaxial tensile test, and FIG. 10D depicts a graph of stress versus strain for the tensile specimens in FIGS. 10A, 10B and 10C.

FIG. 11 depicts flow diagrams for 3D printing showing a conventional route of 3D printing of high-resolution lattice structures and a novel route for 3D printing of high-resolution lattice structures in accordance with present embodiments.

FIG. 12 depicts the process of FIG. 11 including chemical structures of a monomer and a crosslinker in accordance with present embodiments.

FIG. 13 depicts an illustration of polymer chemistry involved in the two-step polymerization of the process of FIGS. 11 and 12 in accordance with present embodiments.

FIG. 14 depicts a graph of ultraviolet (UV) polymerization in accordance with the present embodiments as measured by Fourier-transform infrared spectroscopy.

FIG. 15, comprising FIGS. 15A and 15B, depicts two high resolution printed lattice structures fabricated in accordance with the present embodiments.

FIG. 16, comprising FIGS. 16A to 16C, depicts the effect of thermal treatment applied for various times on mechanical properties of structures fabricated in accordance with the present embodiments, wherein FIG. 16A depicts a graph of the storage modulus versus temperature, FIG. 16B depicts a graph of tans versus temperature, and FIG. 16C depicts a graph of the rubbery modulus versus thermal treatment duration.

FIG. 17, comprising FIGS. 17A to 17C, depicts mechanical properties of samples printed with reprocessable thermosets in accordance with the present embodiments, wherein FIG. 17A depicts a graph of stress vs. strain for printed structures and thermally treated structures, FIG. 17B depicts an illustration of the effect of uniaxial tensile tests on deformation force before and after the thermal treatment, and FIG. 17C depicts use of the stiffness properties to provide for reduced time 3D printing structures.

FIG. 18 depicts an illustration of repair of a 3D rabbit in accordance with the present embodiments.

FIG. 19, comprising FIGS. 19A and 19B, illustrates the repair mechanism in accordance with the present embodiments, wherein FIG. 19A depicts chemically illustrates the repair mechanism and FIG. 19B depicts a graph of the temperature effect on stress relaxation.

FIG. 20, comprising FIGS. 20A to 20E, depicts uniaxial tensile tests on a control structure, a flawed structure and a structure repaired in accordance with present embodiments, wherein FIG. 20A depicts the control structure, FIG. 20B depicts the flawed structure, FIG. 20C depicts the repaired structure, FIG. 20D depicts tested repaired structure and FIG. 20E depicts a graph comparing the mechanical performance in uniaxial tensile tests for the various structures of FIGS. 20A to 20D.

FIG. 21, comprising FIGS. 21A to 21C, depicts a comparison of various 3D printing materials and their recyclability, wherein FIG. 21A depicts structures of the various materials at room temperature, FIG. 21B depicts the materials at thigh temperatures, and FIG. 21C depicts recycling of the #D thermoset material in accordance with present embodiments.

And FIG. 22 depicts a graph of uniaxial testing results for repeatedly recycled samples of fabricated structures in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiments to present a novel digital light processing (DLP)-based micro-stereolithography three-dimensional (3D) printing system capable of producing high-resolution components made of multiple materials in a fully automated, efficient, layer-by-layer manner. The new minimal-waste material exchange mechanism involves an air jet to remove residual liquid resin attached to the substrate after each exposure, which eliminates the need to use cleaning solutions that have been known to damage printed features. It is the intent of the present embodiments to also present a two-step polymerization strategy to develop 3D printing reprocessable thermosets (3DPRTs) that allow users to reform a printed 3D structure into a new arbitrary shape, repair a broken part by simply 3D printing new material on the damaged site, and recycle unwanted printed parts so the material can be reused for other applications.

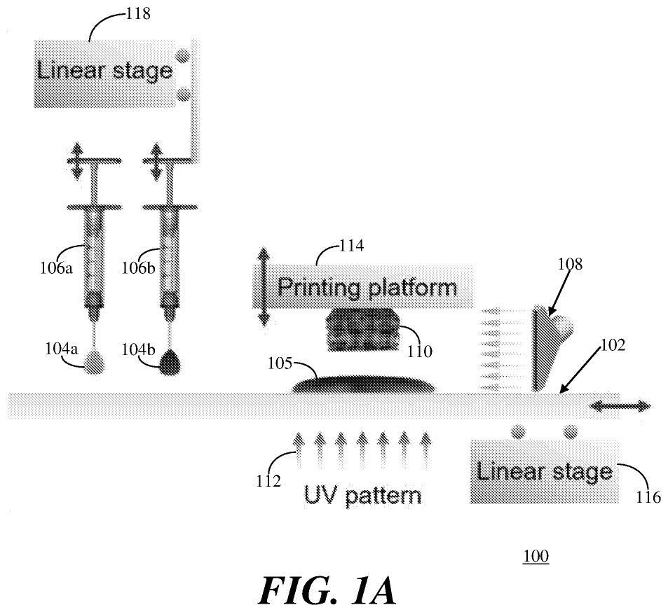

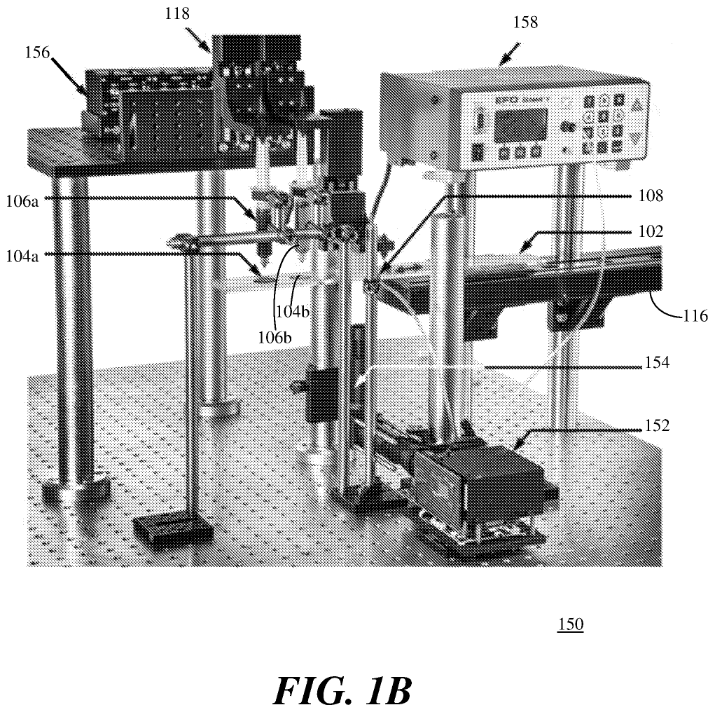

Referring to FIGS. 1A and 1B, a schematic illustration 100 and a photographic illustration 150 depict a DLP based multimaterial 3D printing system in accordance with present embodiments that uses a translationally moved glass plate 102 to deliver different material puddles 104a, 104b deposited from syringe pumps 106a, 106b (i.e., dispensers of the material puddles 104a, 104b) to realize a fast-speed material exchange, and advantageously employs an air jet 108 for an air-based cleaning step to minimize resin waste and material contamination and avoid the use of cleaning solutions as cleaning solutions have been proven to be damaging to printed structure 110.

The basic components of the apparatus are shown in the illustrations 100, 150, in which liquid UV photocurable resins 104a, 104b in a puddle 105 are subjected to patterned UV projections 112 in an upward direction through the glass plate 102. The glass plate 102 could be borosilicate glass plate that is covered on the top surface with optically-clear polytetrafluoroethylene (PTFE) silicone-adhesive tape. When used with PTFE, the PTFE (e.g., such as Teflon™ by Chemours) facilitates the separation of the printed layers from the glass plate such that new layers adhere to the printing platform 114 but not to the glass plate.

The plate 102 is horizontally-translated using a translational stage 116. UV wavelength patterns 112 (e.g., 405 nm-wavelength UV patterns) are projected upward through the glass plate 102 at a UV curable area of the plate using a digital light processing (DLP) light engine 152 and optical elements 154 acting as a UV radiation device. A linear stage 118 is coupled to the syringe pumps 106a, 106b for controlled deposit of the different material puddles 104a, 104b at a dispensing area located under the syringe pumps 106a, 106b. A controller 156 is coupled to the linear stages 116, 118 for coordinating the deposition of the resin puddles 104a, 104b and the translation of the plate 102 to place the combined puddle 105 above the UV pattern 112 and below the printing platform 114. In accordance with the present embodiments, an air dispenser 158 is coupled to the air jet 108 and the controller 156 for the air-based cleaning step coordinated with the puddle deposition and the plate 102 translation to blow air through the air jet to minimize the resin waste and material contamination. The resin waste removed by the air jet 108 includes untransformed residue of the puddles 104a, 104b (i.e., portions of the puddles 104a, 104b which have not become part of the 3D printed part 110).

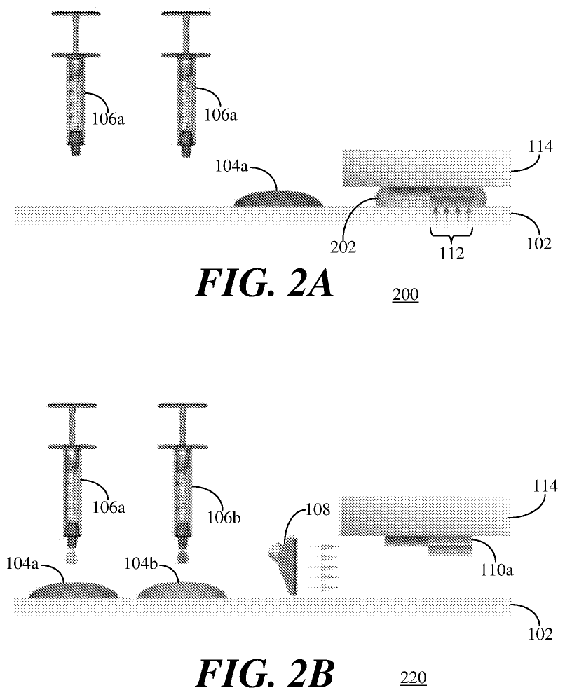

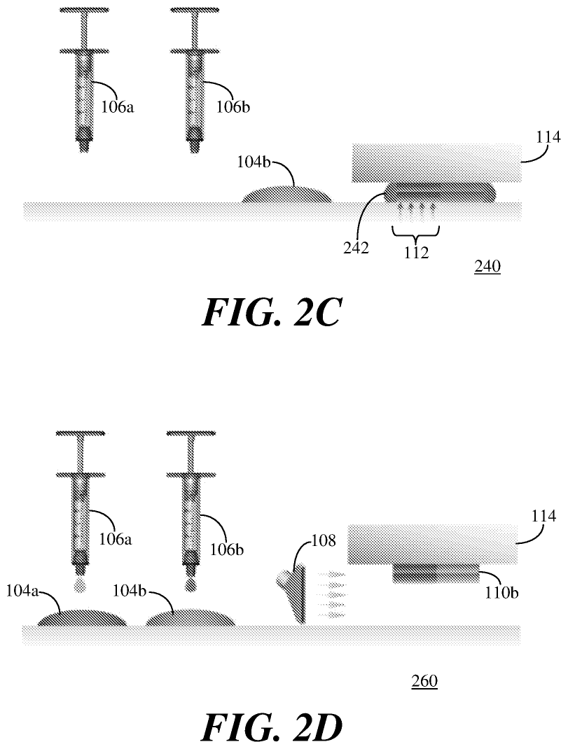

Referring to FIGS. 2A to 2D, schematic illustration 200, 220, 240, 260 depict steps in an efficient material-exchange mechanism in accordance with the present embodiments where the glass plate 102 also serves to deliver the various material puddles 104a, 104b to the printing platform 114 to enable the multimaterial printing. Various photocurable resins are contained in the different syringes 106a, 106b and deposited on the glass plate 102 by automatically controlling the linear stage(s) 118 connected to the syringes. The material exchange mechanism advantageously incorporates a five second blast of a 0.5 MPa air jet through a 2 mm-diameter tubing placed approximately 20 mm away from the substrate 202, 242, controlled in sequence using the high-precision air dispenser 158.

The schematic illustrations 200, 220, 240, 260 depict the primary steps used in the fabrication of multimaterial components in accordance with present embodiments. In the illustration 200, a first step locates the printing platform 114 above the glass plate 102 at a distance equal to a prescribed layer thickness. In this position, the liquid resin 104b is contained between the printing platform 114 and the glass plate 102. The UV pattern 112 of the regions within the layer containing material 104b is projected, leaving blank spaces for the material 104a. This is followed by raising the printing platform 114 to a height of 5 mm above the glass plate 102, then horizontally moving the glass plate 102 to the position where the puddles 104a, 104b are underneath their respective syringe pumps 106a, 106b.

As shown in the illustration 220, a second step refills the puddles 104a, 104b while the air jet 108 is activated to clean any remaining liquid resin attached to the partially printed structure 110a. The glass plate 102 is then horizontally moved back to the position where the partially printed structure 110a is above the puddle containing material 104a, followed by the vertical motion of the printing platform 114 to maintain the structure with a consistent layer thickness while resting within the puddle.

In the illustration 240, a third step projects an image to a blank space next to a portion of the printed structure in the same way as the first step (illustration 200), but using the material 104a. At completion of the third step, the two-material layer is fully-formed and the printing platform is raised by 5 mm followed by horizontal translation of the glass plate 102 to the position shown in the fourth step (illustration 260) for cleaning and puddle re-filling. The cycle is then repeated for subsequent layers.

The electronic components of the apparatus are controlled in sequence by the controller 156 using software code. A three-dimensional computer-aided design (CAD) structure is sliced into a series of 2D images with a prescribed layer thickness. The 2D images are later transmitted to the DLP based UV projector 152 as the dynamic mask which irradiates the modulated near UV light (e.g., 405 nm) 112 with the corresponding 2D image for each layer onto the surface of polymer resin. The UV radiation 112 triggers the photopolymerization which connects monomers, oligomers, and crosslinkers to macromolecules, and solidifies the liquid solution into a solid patterned layer.

Table 1 shows properties of commercial photocurable resins designed for stereolithographic 3D printing suitable for the present embodiments, including: 3DM-ABS (manufactured by Kudo 3D of Dublin, Calif., USA) and VeroClear, VeroWhite, and VeroBlack (all manufactured by Stratasys Ltd. of Eden Prairie, Minn., USA). Fluid viscosities were measured using a hybrid rheometer using a 20 mm flat tip over a 50 mm Peltier plate. In addition to using commercial resins in systems in accordance with the present embodiments, such systems can fabricate components made of a broad range of photocurable resins including various types of monomers, oligomers, initiators, and absorbers suited for various applications.

TABLE 1

| | Liquid photocurable resin | | | | |
|---|---|---|---|---|---|
| Property | 3DM-ABS | VeroClear | VeroWhite | VeroBlack | TangoPlus |
| Viscosity at 25° C. (cP) | 20-25 | 70-75 | 70-75 | 70-75 | 10-30 |
| Modulus of elasticity (GPa) | 1.0-2.9 | 2.0-3.0 | 2.0-3.0 | 2.0-3.0 | 0.02-0.03 |
| Shore hardness | 84 (D) | 83-86 (D) | 83-86 (D) | 83-86 (D) | 26-28 (A) |
| Polymerized density (g/cm3) | 1.01-1.21 | 1.18-1.19 | 1.17-1.18 | 1.17-1.18 | 1.12-1.13 |

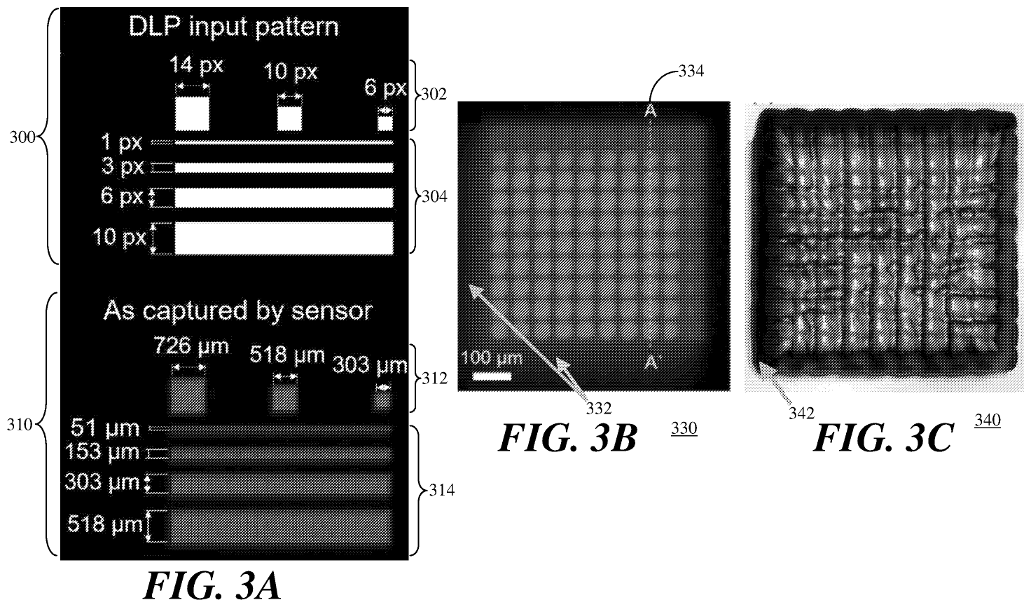

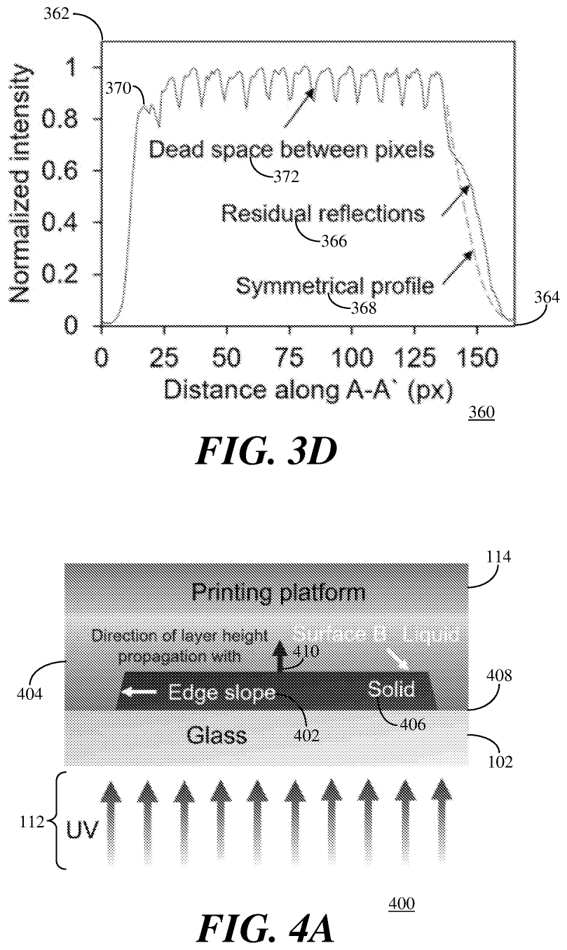

FIGS. 3A to 3D depict characterization of UV patterns projected by the DLP light engine 152 in accordance with the present embodiments. Referring to FIG. 3A, test pattern inputs 300 to the DLP 3D printing system 100, 150 are depicted along with sensor captured patterns 310 at a focus plane of the DLP 3D printing system 100, 150. The input of squares 302 and lines 304 having widths and thicknesses ranging from one to fourteen pixels were input into the DLP 152 and produced square images 312 and line images 314 ranging from 51-726 μm.

FIG. 3B depicts a magnified image 330 of a UV pattern projected by the DLP light engine 152 for printing a layer of the 3D printed structure 110. Projected patterns, such as the patterns 310 and the image 330 of the UV pattern, were captured as images for analysis at a focal plane DLP light engine 152. The quantitative analyses of the images of the pattern 330 was performed using digital software. A 3D digital microscope was used to quantify thicknesses and surface topographies of liquid and solidified layers with vertical and lateral accuracies of ±5 μm. The image 330 of the 10 pixel-wide square reveals that there were asymmetric reflections 332 in two of the four edges, presumably due to the stray light resulting from the tilting of a micro-mirror array in the optical elements 154. Referring to FIG. 3C, a top planar microscope image 340 of a printed layer on the glass plate 102 also shows that the shape of a solid layer produced using the pattern 300 corresponded to the overall shape of the image 330, including the residual solidifications 342 in two of its edges. The pixels in the top and right sides of the image 340 appear well-defined, whereas the left and bottom edges are smoothed and expanded by the undesired solidification 342 caused by the reflections 332.

FIG. 3D is a graph 360 depicting normalized gray value intensity 362 versus pixel distance 364 along line A-A′ 334 in the image 330. Residual reflections 332 of stray light is also evident in the normalized light intensity plot 360, which shows that the shape of the curve 366 is not symmetric 368 as expected. Moreover, the smaller peak 370 at the left side of the plot 360 compared to the rest of the peaks demonstrate the superposition of the neighboring reflections which occurred in the direction toward the bottom left of the square pattern 330. However, this effect produced an error of less than 5% in the lateral edge definition. The dead space 372 between pixels evident in the light intensity plot 360 was apparent in the topography of the image 340 of the printed layer. This shows that surface roughness of printed layers is highly sensitive to the uniformity of the projection. In summary, despite the variations in the light intensity across pixels in the plot 360, the DLP based 3D printing system 100, 150 enables high-resolution features with the use of optical elements 154 that reduced the pixel size to about 15 μm.

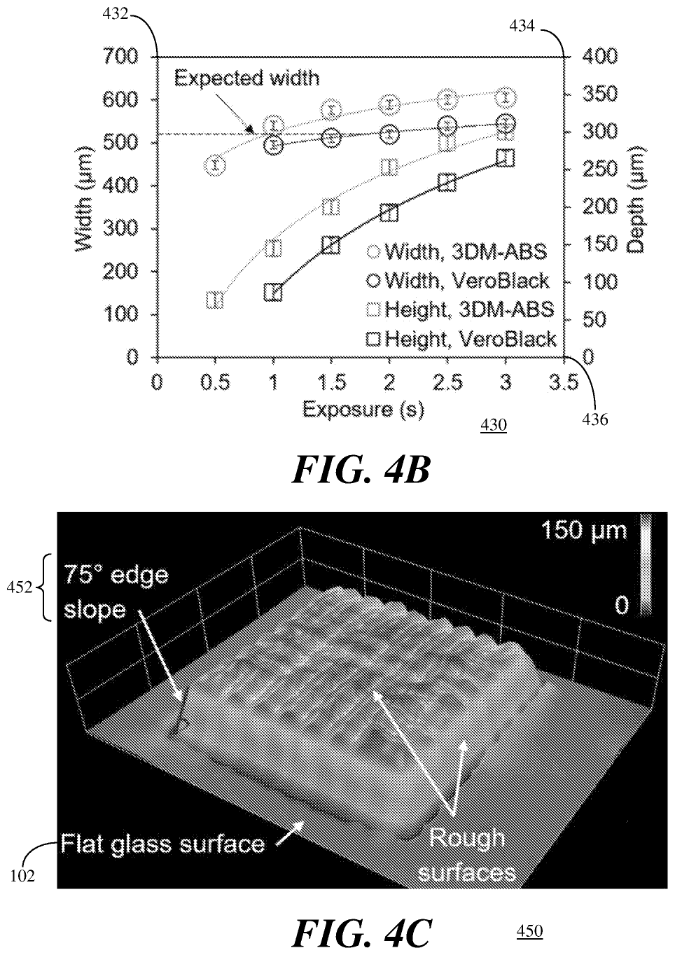

To secure high-resolution 3D printing in the DLP based 3D printing system 100, 150, the effects of curing time on curing width and depth was investigated. Referring to FIG. 4A, a cross-sectional schematic illustration 400 of an edge slope 402 formed in the bottom-exposure printing configuration of the DLP 3D printing system 100, 150 is depicted. Patterned UV light 112 irradiated a polymer resin 404 placed between the glass plate 102 and the printing platform 114. The distance between the glass plate 102 and the printing platform 114 was relatively large such that the height of the patterned polymer 406 did not reach the printing platform 114. As shown in the illustration 400, resin solidification begins to occur at the glass-liquid interface 408, then propagates in a direction 410 upward toward the printing platform 114 with increasing exposure. A graph 430 (FIG. 4B) plots width 432 and height 434 versus exposure time 436 for the projected UV pattern for formation of the two-material structure 406 using the polymer resins 3DM-ABS and VeroBlack. From the graph 430, it can be seen that the width and height of layers made of both materials increased in a less-than-linear manner with increasing exposure, with the height increasing at a greater rate than the width. This is explained by the expected reduction in intensity as light propagates through any liquid as explained by the Beer-Lambert Law. The light intensity further-reduced with increasing layer thickness to give the decreasing slope of the height plots in the graph 430. Referring to FIG. 4C, a 3D surface topography illustration 450 of a one second exposure for one material layer in the formation of the two-material structure 406 is depicted. The Beer-Lambert Law effect also produced an edge slope 404, 452 of about 75°. Both materials produced a measured edge slope 452 of a similarly-sized layer at about 75°, indicating that resin clarity did not have a significant effect on edge slope. Referring back to the graph 430, an exposure of 0.5 seconds did not produce a solid layer using the VeroBlack resin, indicating that the total energy delivered to the resin over the 0.5 second exposure time was less than the minimum required for the cross-linking reaction initiation. This minimum threshold was lower for the 3DM-ABS resin, since, as shown in the graph 430, a solid layer of the 3DM-ABS resin did indeed form at the 0.5 second energy exposure level.

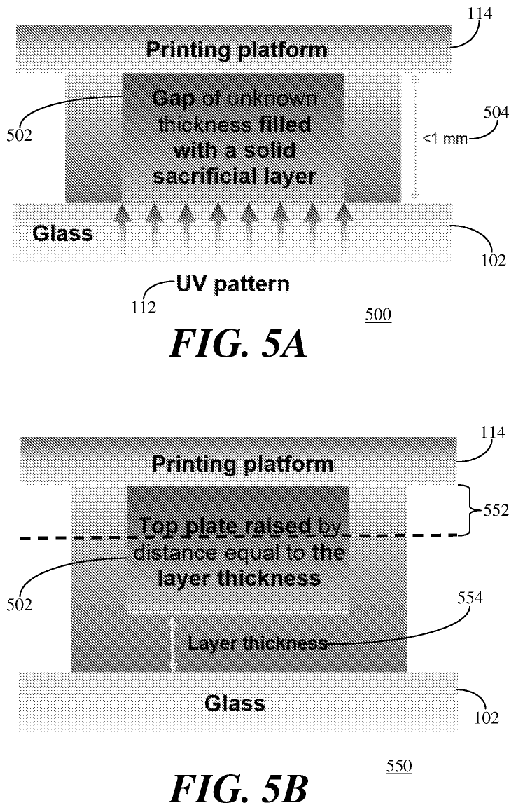

Since the initial distance between the printing platform and glass plate is unknown, each printing process requires the use of a sacrificial layer. Referring to FIGS. 5A and 5B, schematic illustrations 500, 550 depict two steps in formation of a sacrificial layer 502 which is used during initiation of the DLP 3D printing process for multimaterial fabrication in accordance with present embodiments. In the first step, as depicted in the schematic illustration 500, the printing platform 114 is manually positioned to within 1 mm above the glass plate 102. This is followed by a relatively long exposure (e.g. 60 seconds) to ensure that a gap 504 is filled with the sacrificial layer 502 that adheres to the printing platform 114. For all subsequent layers (the step depicted in the schematic illustration 550), the printing platform 114 is raised by a distance 552 equal to a desired layer thickness 554 after the printing of each layer.

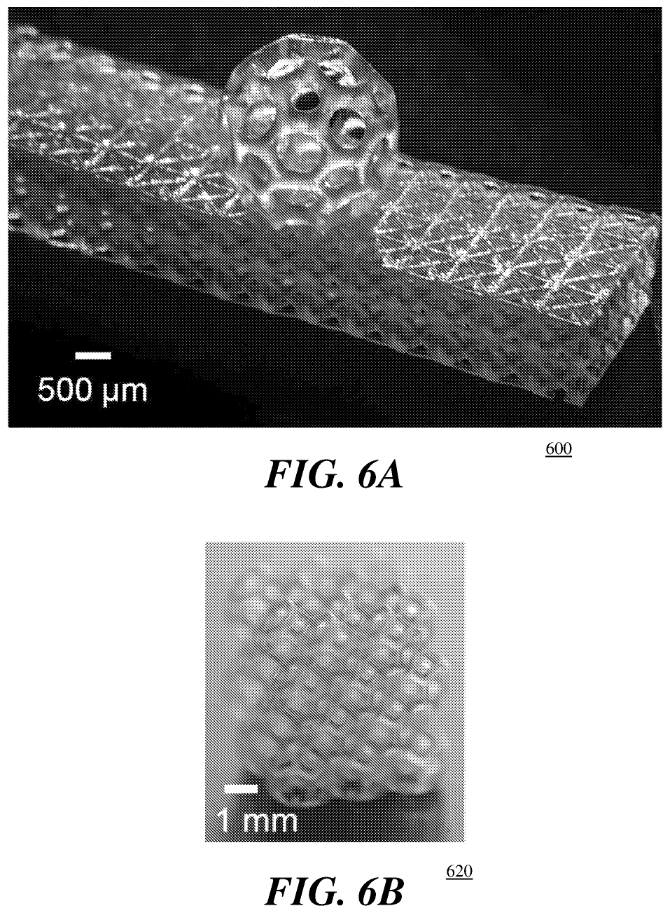

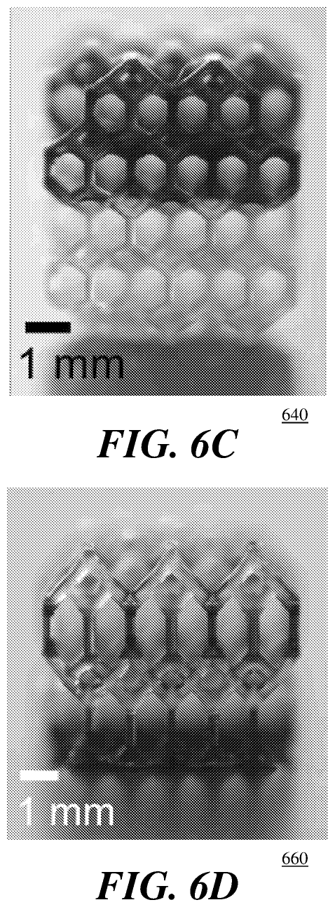

Referring to FIGS. 6A to 6D, illustrations 600, 620, 640, 660 depict shows high-resolution (15 μm pixel size) single and two-material structures printed using the materials in Table 1 and the DLP 3D printing systems and methods in accordance with present embodiments. The prescribed layer thickness, corresponding to the distance 554 by which the printing platform 114 was moved, was 25 μm. The illustration 600 depicts a high-resolution illustration of a two-material structure on top of a single material structure, the illustration 620 depicts a fabricated single material structure, the illustration 640 depicts a first two-material structure, and the illustration 660 depicts a second two-material structure. The single material structures were formed using 3DM-ABS resin while the two-material structures were formed using 3DM-ABS resin and VeroBlack resin (each layer being formed of only one resin material). These substrates demonstrate the high-resolution capability of the DLP 3D printing system 100, 150 in accordance with present embodiments.

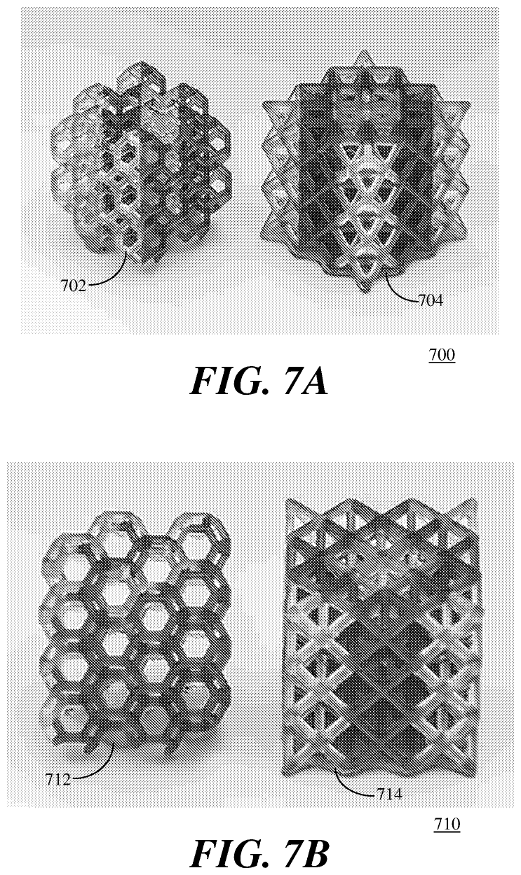

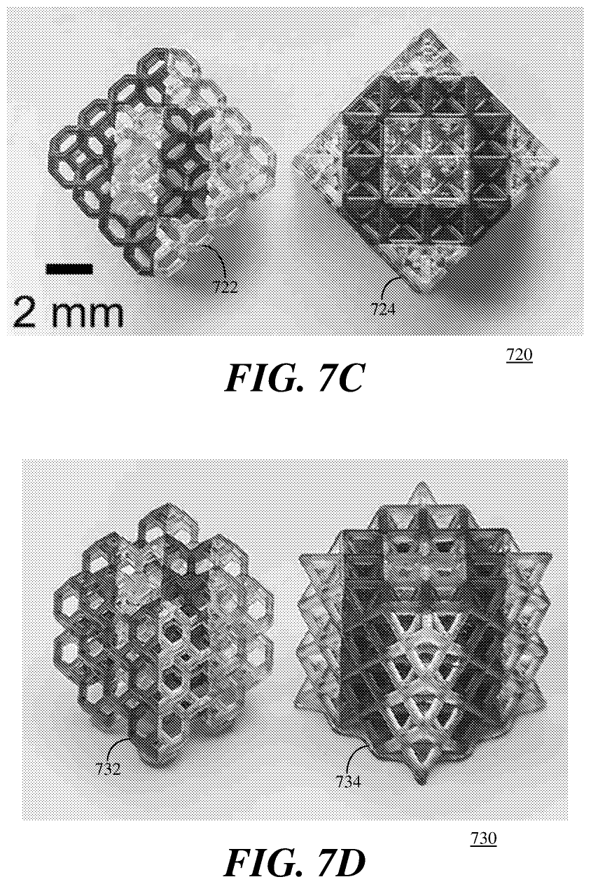

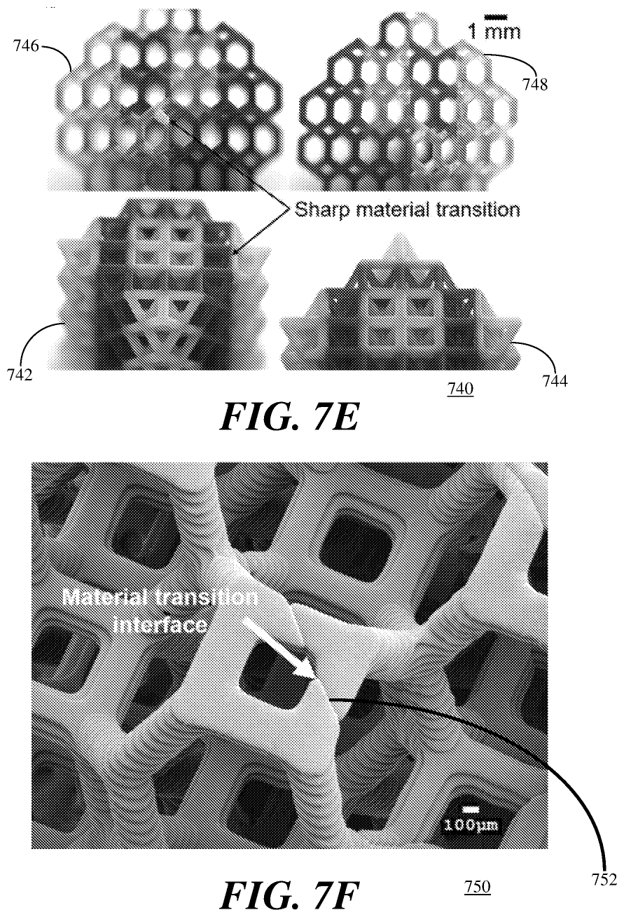

Referring to FIGS. 7A to 7E, illustrations 700, 710, 720, 730, 740 depict multimaterial fabrication capability and performance where the structures 702, 704, 712, 714, 722, 724, 732, 734, 742, 744 are printed in which every layer consists of two different materials. While the exposure time for the 3DM-ABS layers and the VeroBlack layers in the structures of the illustrations 600, 620, 640 660 were 2.5 seconds and 3.5 seconds, respectively, the multimaterial structures the structures 702, 704, 712, 714, 722, 724, 732, 734, 742, 744 took approximately 2.2 times longer to fabricate than either of the single-material structures with otherwise identical printing conditions. This was because for a given layer, the two-material process required two equal-duration exposures, translational motion of the glass plate, and air jet cleaning as shown in the fabrication step illustration 200, 220, 240, 260. For example, the multimaterial lattice structures 702, 704, 712, 714, 722, 724, 732, 734, 742, 744 consisted of 126 25 μm-thick layers and took about 75 min to fabricate with sharp material transitions shown in cross-sectional slices 746, 748 of the structures 742, 744, respectively.

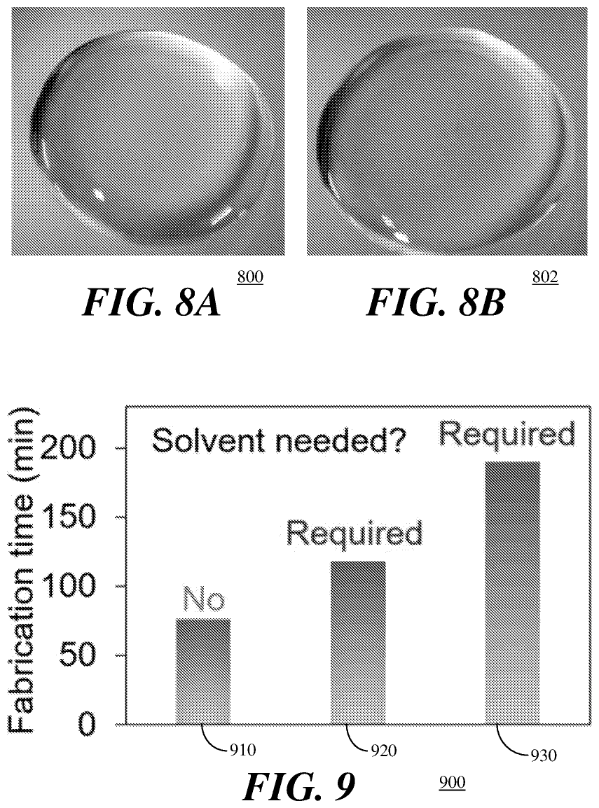

The effectiveness of the air jet 108 cleaning process in accordance with present embodiments is demonstrated by the sharp transition interface 752 from one material to another as evident in the scanning electron micrograph (SEM) 750 of FIG. 7F as well as the photographs 800, 802 of FIGS. 8A and 8B, respectively, of VeroClear resin puddles before and after printing wherein minimal contamination (i.e., perfusion) from the second material, VeroBlack resin, during the exchange process (fabrication illustration 200, 220, 240, 260). As depicted in the fabrication illustrations 220, 260, the air blasting from the air jet 108 is directed at the printed substrate only without removing the puddle. Thus, the material of the puddles is preserved (i.e., not removed by the air jet 108 blast), thereby advantageously preserving the puddles and significantly reducing the degree of material waste. A five second 0.5 MPa blast of the air jet 108 at a standoff of 20 mm was found to sufficiently remove any liquid resin attached to the substrate, presumably facilitated by the resins' relatively low viscosity as given in Table 1. Although this process is reasonably efficient, the waste can be further reduced to virtually zero by collecting and recycling the air-blasted resins of various types using separate catcher bowls to collect each resin.

One typical multiple-vat, multimaterial DLP-based system dips printed structures in isopropyl alcohol (IPA) followed by submergence into a secondary resin vat after each exposure, increasing the likelihood of contaminating a large volume of secondary resin and potentially rendering it unusable. Comparatively, systems and methods in accordance with the present embodiments afford the advantage of eliminating harsh cleaning solutions without introducing any additional resin waste. The 6 mm³ lattice structure 750 required about 8 mL of resin.

FIG. 9 depicts a bar graph 900 of a printing speed 910 of a 6 mm long, 6 mm wide and 6 mm high lattice structure consisting of 120 layers, each layer being 50 μm-thick, and made of two materials between the DLP 3D printing system 100, 150 in accordance with the present embodiments as compared to the printing speeds 920, 930 required by two prior art DLP-based multimaterial systems for printing lattice structures with the same dimensions. It can be seen from the bar graph 900 that processing in accordance with the present embodiments is approximately 36% and 80% quicker than the durations 920, 930, respectively of the two prior art systems. Moreover, systems and methods in accordance with the present embodiments do not require the use of harsh cleaning solutions, such as IPA, known to chemically-damage solidified photocurable resins upon exposure. Additionally, the process time in accordance with present embodiments could be significantly further reduced chemically using photoinitiator additives with higher sensitivity to the system's 405 nm irradiation, or mechanically by utilizing commercially-available high-speed translational stages with 400 mm/s maximum velocities as compared with the presently-employed 50 mm/s stages.

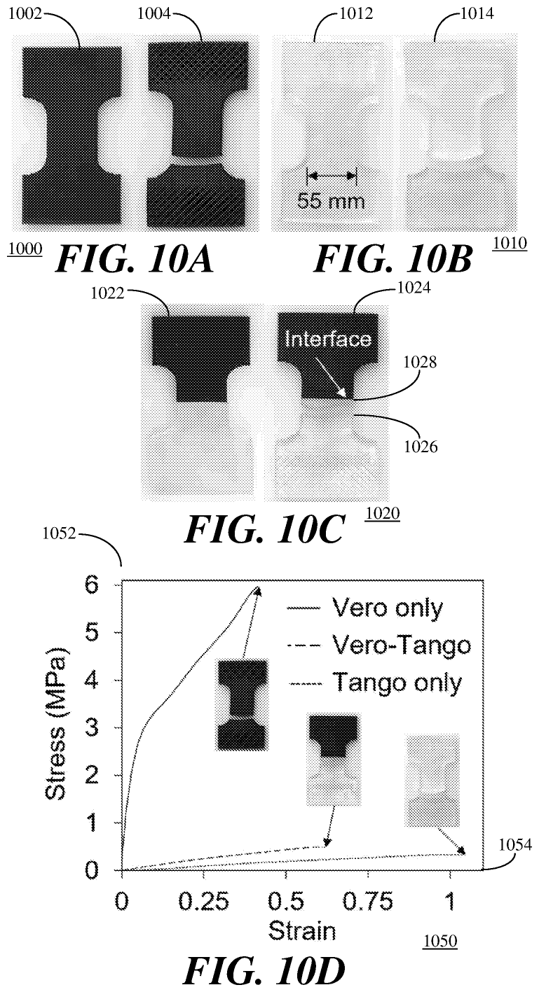

Referring to FIGS. 10A to 10D, photographic illustrations 1000, 1010, 1020 and a graph 1050 depict and characterize the strength of a bond formed between layers of differing materials using tensile specimens made of VeroBlack and TangoPlus materials by the DLP 3D printing systems and methods in accordance with present embodiments. The photographic illustration 1000 depicts a first photographic image 1002 of a tensile specimen made of VeroBlack resin before a uniaxial tensile test and a second photographic image 1004 of the tensile specimen of VeroBlack resin after the uniaxial tensile test. The photographic illustration 1010 depicts a first photographic image 1012 of a tensile specimen made of TangoPlus resin before the uniaxial tensile test and a second photographic image 1014 of the tensile specimen of TangoPlus resin after the uniaxial tensile test. And the photographic illustration 1020 depicts a first photographic image 1022 of a half-and-half composite tensile specimen made of VeroBlack resin and TangoPlus resin before the uniaxial tensile test and a second photographic image 1024 of the composite tensile specimen after the uniaxial tensile test. TangoPlus was selected for its flexibility as compared to VeroBlack, as evidenced in the uniaxial tensile test plot 1050 of stress 1052 versus strain 1054 for the tensile specimens in photographic illustrations 1000, 1010, 1020. The photographic images 1004, 1014, 1024 also show that the fracture paths in all three specimens occurred in the narrow cross-section, and, in the photographic image 1024, at a location 1026 away from the Vero-Tango interface 1028, demonstrating that the interfacial bond strength between the two materials was reasonably good. The Young's moduli, computed using the data in the graph 1050 as 129.9 MPa, 1.1 MPa, and 0.4 MPa for Vero only, Vero-Tango, and Tango only specimens, respectively, were much smaller than those provided by the manufacturer in the data of Table 1, likely due to the solid layers produced in the tensile specimens were formed by gelation rather than complete polymerization because the light intensity and exposure times used to form the tensile specimens did not complete the polymer cross-linking reaction. It should be noted that the samples were not treated in a UV oven after printing to prevent non-uniformity in stiffness, since, although the exterior may have been further-stiffened, the UV rays would not effectively reach the core. Thus, fabrication of multimaterial 3D structures in accordance with the systems and methods of the present embodiments may have important implications in tailorable mechanical properties through light-control.

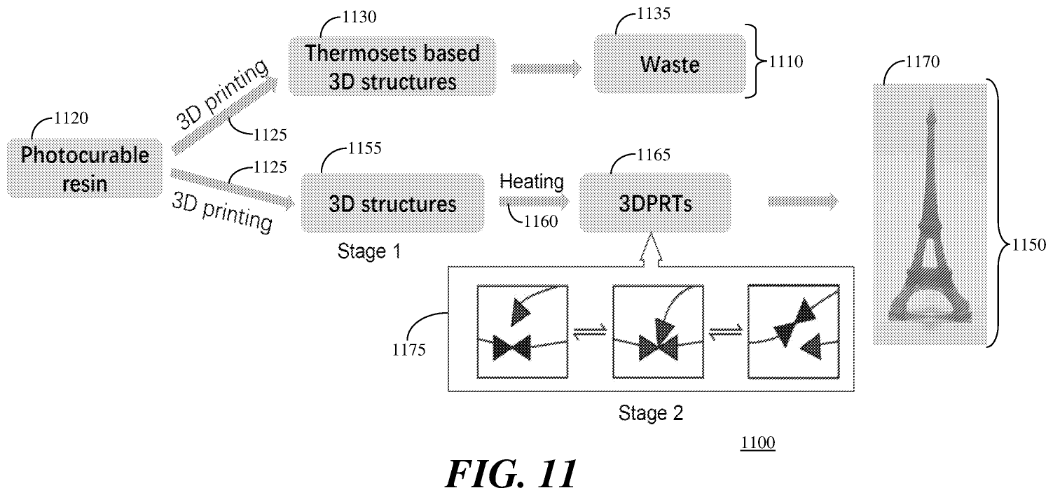

In accordance with a second aspect of present embodiments, a two-step polymerization strategy and a simple preparation method in accordance with present embodiments for a type of 3D printing reprocessable thermosets (3DPRTs) for UV curing-based high-resolution 3D printing. Referring to FIG. 11, a schematic illustration 1100 depicts a first flow diagram 1110 and a second flow diagram 1150. In accordance with the first flow diagram 1110, UV-photocurable resin 1120 using conventional 3D printing techniques 1125, such as DLP, mask projection stereolithography, or two-photon lithography, will produce thermoset-based 3D structures 1130. Such 3D structures 1130, however, are not recyclable, so once the fabricated 3D structure 1130 breaks, it becomes waste 1135 as it cannot be reprocessed.

In accordance with the second flow diagram 1150, a thermosetting polymer process in accordance with present embodiments uses UV curing-based 3D printing techniques 1125 to fabricate high-resolution 3D structures 1155 with complex geometries (Stage I). UV reactive acrylate functional groups in the UV-photocurable resin 1120 allow compatibility with UV curing-based 3D printing techniques (e.g., DLP, mask projection stereolithography, or two-photon lithography as utilized for the first flow diagram 1110). A transesterification reaction between the hydroxyl and ester functional groups upon heating 1160 then forms dynamic covalent bonds (DCBs) that impart reprocessability into 3D printing reprocessable thermosets (3DPRTs) 1165 so that the printed structures 1170 are reproceesable and do not simply become waste when no longer needed or when broken. The inset 1175 (Stage II) depicts that the transesterification reaction between the hydroxyl and ester functional groups upon heating 1160 which forms the DCBs can be used to repair or reprocess the printed structures 1170 in accordance with the present embodiments.

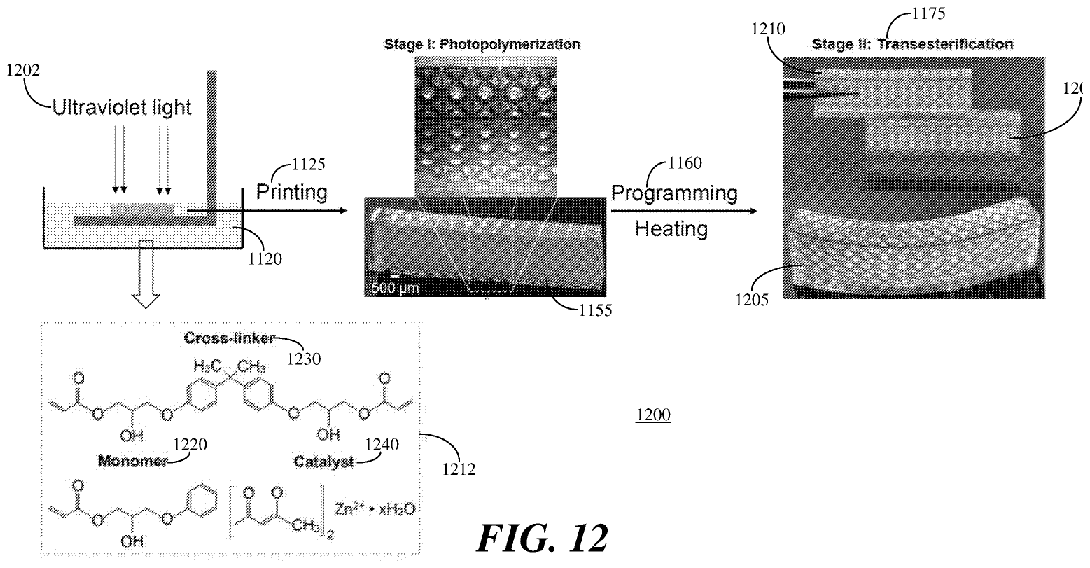

FIG. 12 depicts an illustration 1200 showing the ultraviolet radiation 1202 used for 3D printing 1125 of the UV-photocurable resin 1120. The resultant high-resolution 3D printed lattice structures 1155 at Stage I (Photopolymerization) is then heated 1160 under programmed heating conditions in accordance with present embodiments at Stage II (Transesterification) to produce reprocessable lattice structures. In accordance with present embodiments, such lattice structures can use novel methods and system in accordance with present embodiments to advantageously (a) program/reprocess a straight lattice structure into a bent one 1205 and (b) weld together two separate printed lattice structures 1208, 1210.

In accordance with the present embodiments, the polymer solution of the UV-photocurable resin 1120 is formed 1212 by mixing 2-Hydroxy-3-phenoxypropyl acrylate as a monomer 1220, Bisphenol A glycerolate (1 glycerol/phenol) diacrylate as a crosslinker 1230, diphenyl (2,4,6-trimethylbenzoly), phosphine oxide as a photo initiator to trigger the UV polymerization, and zinc acetylacetone hydrate as a catalyst to accelerate the transesterification reaction 1175.

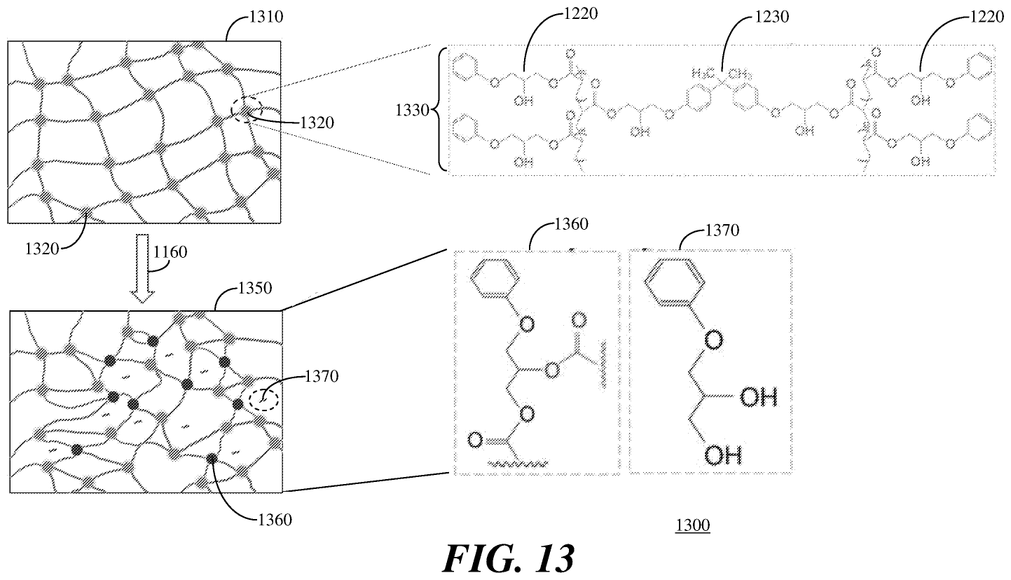

Referring to FIG. 13, an illustration 1300 depicts polymer chemistry involved in the two-step polymerization of the 3D printing 1125 of the process depicted in the illustration 1200 in accordance with present embodiments. A first step 1310 includes UV curing which forms permanent covalent bonds 1320 between the monomers 1220 and the crosslinker 1230. During 3D printing, patterned UV irradiation 1202 (FIG. 12) provided, for example, via a digital micromirror device, stimulates localized photopolymerization by opening the double bonds on the acrylate functional groups on both the monomer 1220 and the crosslinker 1230 to form covalent bonds and solidify the liquid polymer solution 1120 into a solid pattern corresponding to the patterned UV irradiation. Layer-by-layer solidification continues until the fabrication of the entire 3D structure 1155 is complete. Chemical structures 1330 illustrate the resultant crosslinked network of stage I including the monomers 1220, the crosslinker 1230 and the covalent bonds 1340 therebetween.

Subsequent heating 1160 to an elevated temperature (for example, 180° C.) at a second step 1350 thermally-triggers the transesterification between the ester and hydroxyl groups, which proceeds at a fast rate resulting in the formation of dynamic covalent bonds (DCBs) 1360 within a few hours. Formation of the DCBs 1360 evolves simultaneous breaking 1370 and reconnecting DCBs 1360 between the ester and hydroxyl groups which means the total number of the covalent bonds maintains the same, as shown in the physical chemistry, while the crosslinking density continues increasing until the reaction reaches dynamic equilibrium.

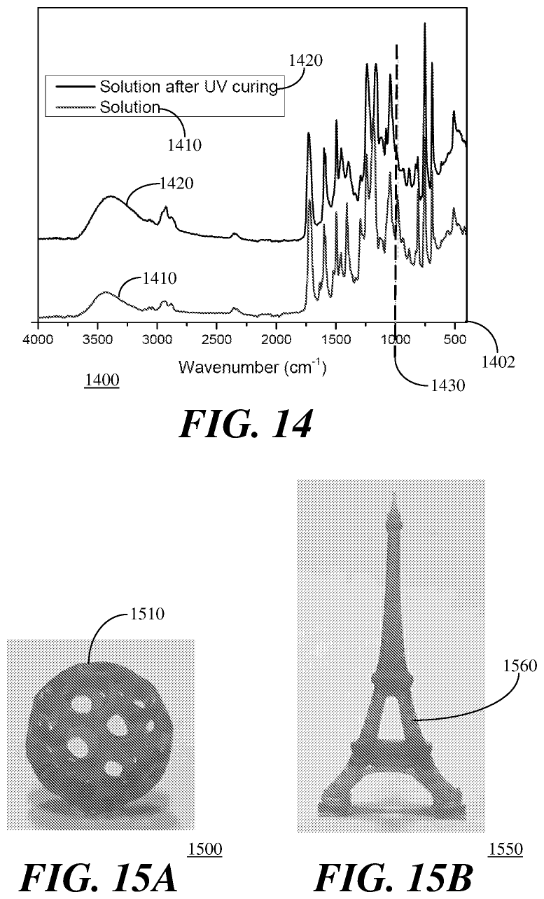

Referring to FIG. 14, a graph 1400 depicts polymerization in a solution of the resin 1120 before 1410 and after 1420 UV curing in accordance with present embodiments. The polymerization in the resin solution 1120 was measured using Fourier-transform infrared spectroscopy. The wavenumber is plotted along the x-axis 1402 of the graph 1400 and disappearance of the absorption peaks of the methylene group (═C—H) at wavenumber 1040 cm⁻¹ 1430 proves full polymerization of all the monomers and crosslinkers after UV curing for five minutes.

FIG. 5 depicts an illustration 1500 of a first high resolution printed lattice structure 1510 in the shape of a bucky ball having a diameter of approximately 1.0 cm and an illustration 1550 of a second high resolution printed lattice structure 1560 in the shape of the Eiffel Tower having a height of approximately 3.0 cm.

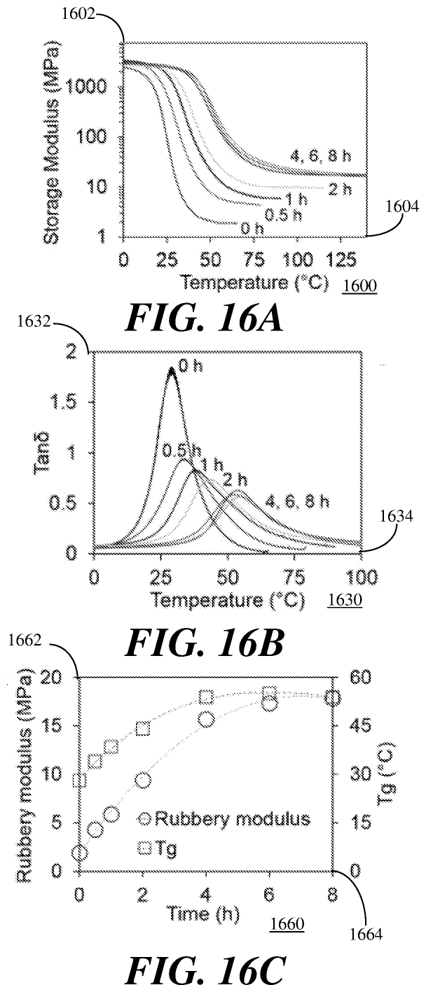

Referring to FIGS. 16A, 16B and 16C, graphs 1600, 1630, 1660 depict the effect of the thermal treatment 1160 on the mechanical properties of structures fabricated in accordance with present embodiments. Referring to the graphs 1600, 1630 the storage modulus 1602 and tan δ 1632 are plotted versus temperature 1604, 1634, where the storage modulus 1602 describes an elastic response of the material of the fabricated structure and the peak of tan δ 1632 indicates a glass transition temperature (T_{g}). As 3D printed strip samples were thermally treated at 180° C. for 0 hours 1606, 0.5 hours 1608, 1 hour 1610, 2 hours 1612, 4 hours 1614, 6 hours 1616, and 8 hours 1618, the increase of the thermal treatment time from 0 hours 1606 to 4 hours 1614 results in a gradual increase in a rubbery modulus (the lower modulus plateau at high temperatures) from ˜2 MPa to ˜20 MPa. The graph 1660 (FIG. 16C) shows the relation between the thermal treatment duration 1664 and the rubbery modulus 1662, which suggests an increase in DCBs during the bond exchange reactions (BERs).

After four hours of thermal treatment, the DCBs reach a dynamic equilibrium beyond which no apparent increase in rubbery modulus in the graphs 1600, 1630 is observed. As shown in the graphs 1630, 1660, the increase in DCBs does not only lead to the rise of the rubbery modulus but also shifts the peak of tan δ 1632 to a higher temperature as the introduction of additional crosslinks restricts segmental chain mobility, and therefore results in the increase in the glass transition temperature T_{g}.

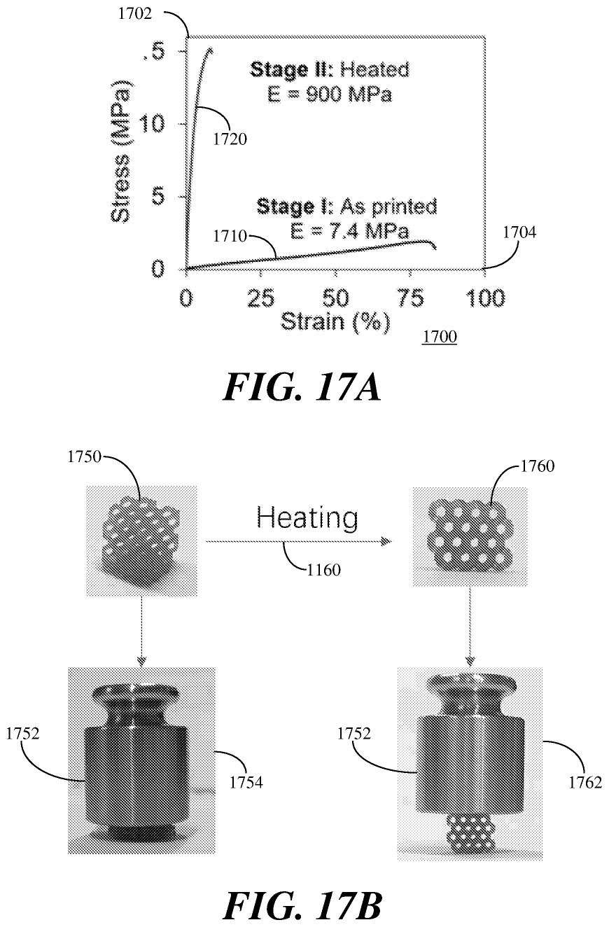

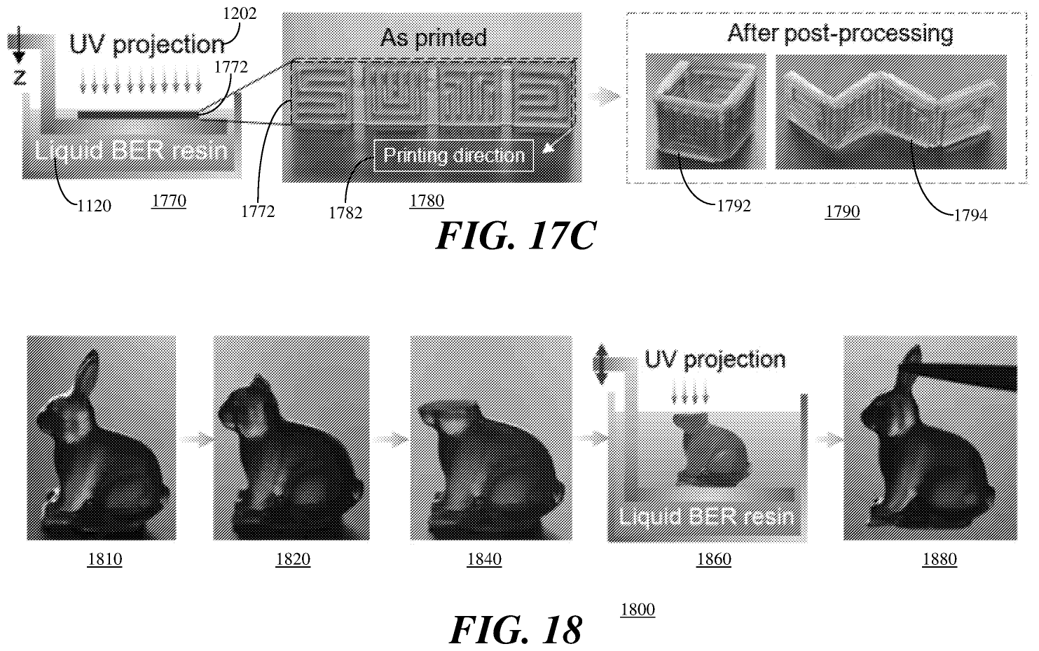

Referring to FIG. 17A, a graph 1700 plots stress 1702 versus strain 1704 for a structure fabricated in accordance with the present embodiments. The increased T_{g} stretches the glassy state to a high temperature region and converts the material of the fabricated structure at room temperature from a compliant material with a Young's modulus of 7.4 MPa as printed at Stage I 1710 into a stiff material with a Young's modulus of ˜900 MPa after being heated at Stage II 1720. This mechanical property change is demonstrated in FIG. 17B, where a 3D Kelvin foam lattice structure 1750 printed without the Stage II thermal treatment 1160 has a 100 g weight 1752 placed on it. The untreated structure cannot support the weight and is deformed severely as seen in the illustration 1754. After a four-hour thermal treatment 1160, the structure stiffness increases significantly and enables the structure 1760 fabricated in accordance with the present embodiments to support the 100 g weight 1752 without any apparent deformation as seen in the illustration 1762.

This significant stiffness increase upon the heat treatment facilitates the reshapability of the 3D printed structures. In accordance with the present embodiments, this property can be exploited to combine 3D printing with traditional manufacturing methods, such as molding, pressing, and thermoforming, to increase manufacturing capabilities and decrease manufacturing time as shown in FIG. 17C. Instead of directly printing 3D standing structures, a thin strip with the letters SUTD 1772 is printed 1770 in the thickness direction 1782, which minimizes the number of layers and thus the printing time. The strip as printed 1780 is then thermoformed 1790 into a 3D cubic shape 1792 and a wavy shape 1794 that would require much longer printing time if they were printed directly.

With conventional thermosetting 3D printing materials, once a printed structure is damaged, it cannot be repaired as the chemically crosslinked networks are permanently destroyed. 3D printing reprocessable thermosets in accordance with the present embodiments change this view as the dynamic covalent bonds make the printed structures repairable through thermally activated self-healing. Referring to FIG. 18, an illustration 1800 depicts repair of a 3D printed rabbit 1810 after the rabbit has lost its ears 1820, by first polishing the damage site 1840 to achieve a flat surface, and then 3D printing 1860 new material on the polished surface to rebuild the missing part of the rabbit. After printing 1860, the rabbit with ears 1880 was heated to 180° C. for 4 hours to regain the mechanical performance.

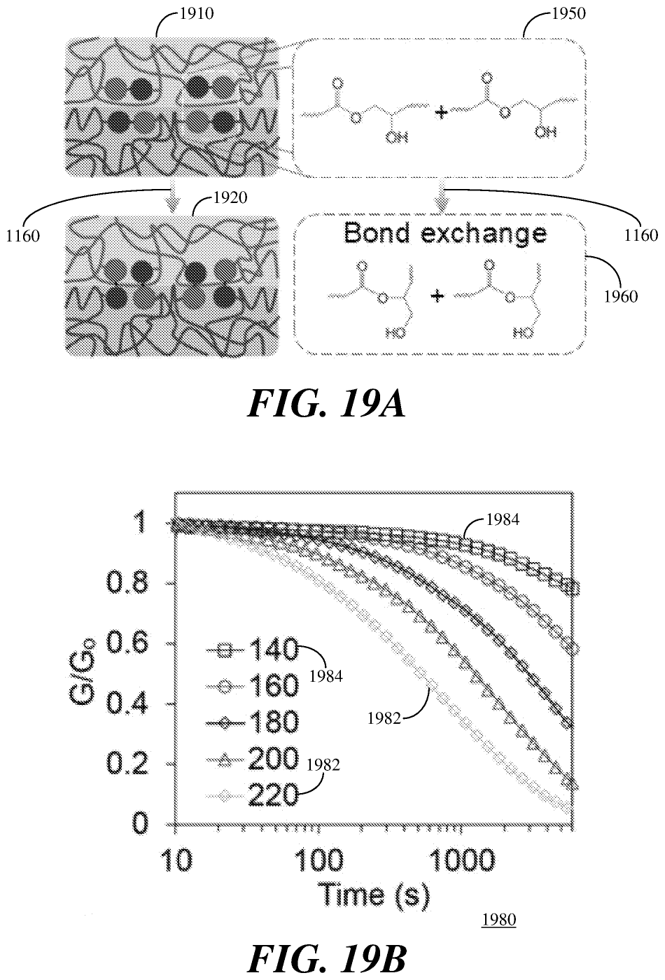

FIG. 19A depicts an illustration 1900 of the repair mechanism based on the heat-triggered BERs where the dynamic crosslinking points break up 1910, 1950 after being attacked by the adjacent hydroxyl functional groups, and later reform new dynamic crosslinking points 1920, 1960 by connecting with the adjacent ester functional groups. The topological rearrangement of the macromolecular networks builds DCBs across the interface, and eventually bonds the original part with the rebuilt part, resulting in a homogeneous repaired solid. Macroscopically, breaking of the dynamic crosslinks during the BER results in stress relaxation. FIG. 19B depicts a graph 1980 of the temperature effect on the stress relaxation. At 220° C. 1982, more than 80% of the stress is relaxed within 40 minutes, while at 140° C. 1984, more than 90% of the stress is unrelaxed. This indicates the BERs are strongly temperature dependent, and the functional groups involved in the BERs are more active at higher temperatures. The temperature dependent characteristic relaxation time τ* can be expressed by the Arrhenius equation with the activation energy Eₐ=77 kJ mol⁻¹, which is similar to other transesterification reaction based polyester networks. During BERs, dynamic equilibrium of the breaking-reforming process renders the total number crosslinks constant, which ensures that the repaired structure largely restores the mechanical performance of the original structure.

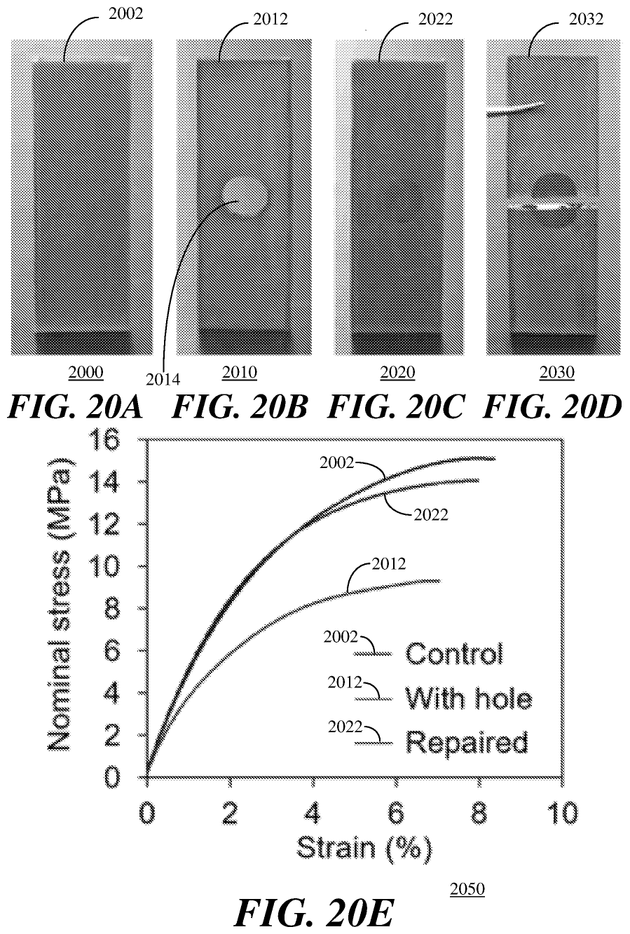

Referring to FIGS. 20A to 20D, a strip with a circular hole was fabricated to simulate a mechanical flaw. In illustrations 2000 (FIG. 2A), 2010 (FIG. 2B), a control strip 2002 without a hole and the strip 2012 with the hole 2014, respectively, are depicted. The hole 2014 in the strip 2012 is filled with the reprocessable thermoset solution, irradiated with UV light, and heated in accordance with the present embodiments as shown in illustration 2020 (FIG. 20C). The repaired strip 2022 (depicted in the illustration 2020) was then submitted to uniaxial tensile tests and the tested repaired strip 2032 is depicted in illustration 2030 (FIG. 20D).

Referring to FIG. 20E, a graph 2050 compares the mechanical performance in uniaxial tensile tests of the unflawed control sample 2002, the flawed sample with a hole 2012, and the repaired sample 2014. As seen from the graph 2050, the repaired sample recovers ˜100% of the stiffness and 93% of the strength indicating the healing progress advantageously and robustly bonds the separate parts and restores the mechanical performance. In addition, the fact that the fracture boundary passes through the repaired circle rather than following the circular boundary in the tested strip in the illustration 2030 (FIG. 20D) demonstrates the robustness of the repair process. In contrast, the same repair approach with a flawed strip sample printed with a conventional thermoset 3D printing material resulted in the improvement in the mechanical performance being limited and the fracture boundary following the repaired circular boundary indicating that any improvement of the repaired conventional thermoset derives from mechanical blocking of the solid material in the circular hole, and not the creation of new covalent bonds between the newly-deposited and existing materials. This clearly highlights the inability to repair conventional 3D printed thermosets.

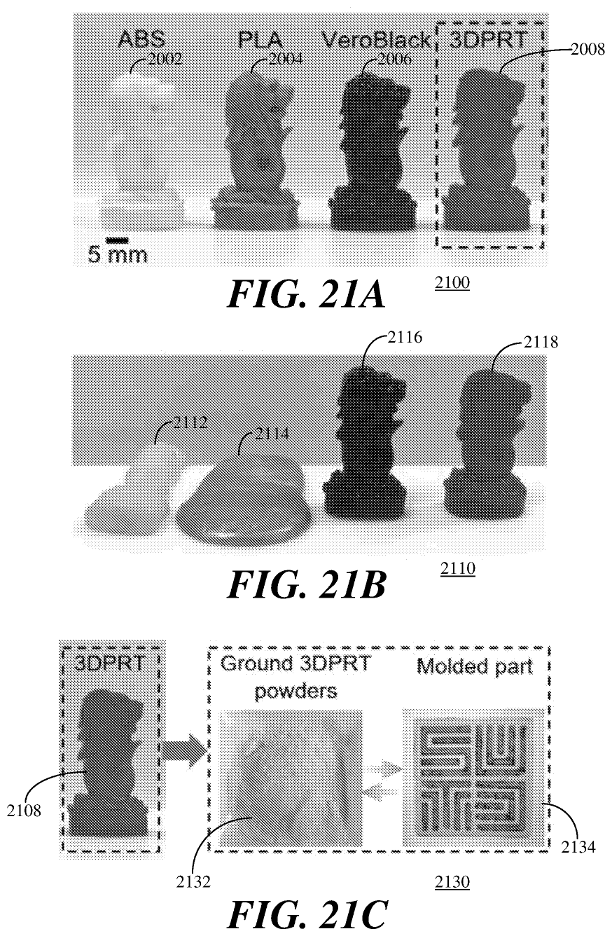

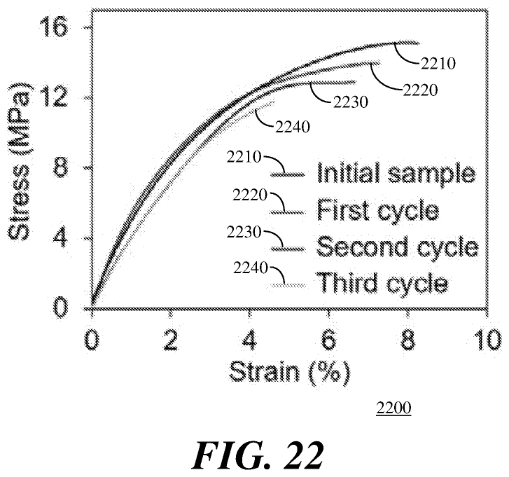

Referring to FIG. 21A, an illustration 2100 depicts initial samples 2102, 2104, 2106, 2108 of a given structure. As seen in the illustration 2110 of FIG. 21B, as compared to thermoplastic 3D printing materials such as Acrylonitrile-Butadiene Styrene (ABS) 2112 and Poly Lactic Acid (PLA) 2114 which melt at high temperatures, thermosetting 3D printing materials (e.g., VeroBlack structure 2116) are dimensionally stable at high temperatures due to the chemically crosslinked networks. However, these chemically crosslinked networks also make recycling of these thermosetting 3D printing materials (e.g., VeroBlack 2106, 2116) technically challenging and/or cost ineffective. The 3DPRT 2108 in accordance with the present embodiments in addition to being dimensionally stable at high temperatures, exploits BERs to realize recyclability of thermoset 3D printing materials, offering a promising contribution to the environmental challenges of polymer recycling. FIG. 21 B depicts an illustration 2110 of recyclability of the thermosetting 3D printing materials in accordance with present embodiments. The 3DPRT structure 2108 was ground into powder 2112. The powder 2112 was then poured into a mold with the SUTD pattern. After the thermal treatment 1160, a thermosetting sheet with SUTD letters 2114 was formed due to the BER. Advantageously, this recycling process is repeatable.

Referring to FIG. 22, a graph 2200 depicts uniaxial tensile testing results for repeatedly recycled samples (an initial sample 2210, a recycled sample 2220, a sample twice recycled 2230 and a sample three times recycled 2240). Despite slight mechanical degradation after each recycling treatment, the overall mechanical performance of the recycled sample is reasonably good.

Thus, it can be seen that the present embodiments provide methods and systems for a novel digital light processing (DLP)-based micro-stereolithography three-dimensional (3D) printing system capable of producing high-resolution components made of multiple materials in a fully automated, efficient, layer-by-layer manner. A high-contrast digital micro display (DMD) with a pixel size of 15 μm was used to project customized 405 nm images through a borosilicate glass plate coated with optically-clear PTFE to induce polymerization in a variety of acrylate-based photocurable polymeric resins, where each layer contained multiple resin types. The new minimal-waste material exchange mechanism advantageously involves an air jet to remove residual liquid resin attached to the substrate after each exposure, which eliminates the need to use cleaning solutions that have been known to damage printed features. Complex, multimaterial micro-lattice structures were printed about 58% faster than existing studies which used cleaning solutions. Mechanical tests of tensile specimens demonstrated that the printing process formed sufficiently strong bonds between differing materials. The multimaterial capabilities of the novel methods and systems using photocurable polymer varieties opens doors for potential high-resolution, high-efficiency, multimaterial fabrication of a broad range of microarchitectures with novel functionalities and optimized performance made of ceramic, metallic, and biomaterials that find applications in the fields of metamaterials, bio-inspired soft robotics, bio-devices, microelectromechanical systems (MEMS), optics, and microfluidics. Successful fabrication of high-resolution two-material lattice structures demonstrates the effectiveness of the material exchange process in accordance with present embodiments by showing minimal resin cross-mixing during the printing.

In accordance with the present embodiments, a two-step polymerization system and method to develop 3D printing reprocessable thermosets (3DPRTs) that allow users to reform a printed 3D structure into a new arbitrary shape, repair a broken part by simply 3D printing new material on the damaged site, and recycle unwanted printed parts so the material can be reused for other applications is also presented. The 3D printing reprocessable thermosets in accordance with the present embodiments provide a practical solution to address environmental challenges associated with the rapid increase in consumption of 3D printing materials

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

1. A method for multimaterial fabrication of three-dimensional (3D) printed structures, comprising the steps of:
lifting a printing platform having a 3D printed structure formed thereon to remove the 3D printed structure from a plate through which radiation was transmitted to fabricate the 3D printed structure; and
activating a blast of an air jet focused on the surface of the plate under the printing platform to remove waste material left on the surface of the plate when the printing platform is lifted.

2. The method in accordance with claim 1, wherein activating the blast of the air jet comprises activating a 0.5 MPa blast of the air jet.

3. The method in accordance with claim 1, wherein activating the blast of the air jet comprises activating a five second blast of the air jet.

4. The method in accordance with claim 1, wherein activating the blast of the air jet comprises:
locating the air jet approximately 20 mm away from and focused on the surface of the plate under the printing platform; and
activating the blast of the air jet to remove the waste material left on the surface of the plate under the printing platform when the printing platform is lifted.

5. The method in accordance with claim 1 further comprising before the step of lifting the printing platform the steps of:
translating the plate having one or more puddles of material on a surface thereof such that at least one of the one or more puddles of material is placed under the printing platform;
lowering the printing platform onto the at least one of the one or more puddles of material; and
exposing the at least one of the one or more puddles of material to patterned ultraviolet radiation to transform the at least one of the one or more puddles of material into a portion of the 3D printed structure.

6. The method in accordance with claim 5, wherein the waste material left on the surface of the plate when the printing platform is lifted comprises an untransformed residue of the at least one of the one or more puddles of material.

7. The method in accordance with claim 5, wherein the one or more puddles of material comprise a liquid UV photocurable resin material.

8. A system for multimaterial fabrication of three-dimensional (3D) printed structures comprising:
a printing platform;
a UV-transparent plate through which radiation is transmitted to fabricate the 3D printed structure on the printing platform; and
an air jet focused on a surface of the UV-transparent plate under the printing platform to use a blast of air to remove waste material left on the surface of the UV-transparent plate when the printing platform with the 3D printed structure attached thereto is lifted a predetermined distance above the surface of the UV-transparent plate.

9. The system in accordance with claim 8, wherein the predetermined distance comprises 5 mm.

10. The system in accordance with claim 8, wherein the air jet provides a 0.5 MPa blast of air to the surface of the UV-transparent plate under the printing platform.

11. The system in accordance with claim 8, wherein the air jet provides a five second blast of air to the surface of the UV-transparent plate under the printing platform.

12. The system in accordance with claim 8, wherein the air jet is located approximately 20 mm away from the surface of the UV-transparent plate that is under the printing platform.

13. The system in accordance with claim 8 further comprising:
dispensers located above the plate at a dispensing area away from the printing platform for dispensing a plurality of material puddles on the surface of the UV-transparent plate; and
an ultraviolet (UV) radiation device located below the UV-transparent plate and under the printing platform to shine through the UV-transparent plate to transform one or more of the plurality of material puddles into a portion of the 3D printed structure attached to the printing platform,
wherein the UV-transparent plate is horizontally translatable to move the plurality of material puddles from the dispensing area to a UV curable area under the printing platform, and
wherein the printing platform is vertically movable such that it can be lowered onto the one or more of the plurality of material puddles at the UV curable area while the one or more of the plurality of material puddles are being exposed to patterned UV radiation from the UV radiation device to transform the one or more of the plurality of material puddles into the portion of the 3D printed structure.

14. The system in accordance with claim 13, wherein the waste material left on the surface of the UV-transparent plate when the printing platform is lifted comprises an untransformed residue of the one or more of the plurality of material puddles.

15. The system in accordance with claim 13, wherein each of the plurality of material puddles comprise a liquid UV photocurable resin material.

16. The system in accordance with claim 8, further comprising:
a first linear stage coupled to the UV-transparent plate for horizontally translating the UV-transparent plate;
a second linear stage coupled to the dispensers for dispensing the plurality of material puddles; and
a controller coupled to first and second linear stages for controlling the movement of the UV-transparent plate and the dispensing of the plurality of material puddles from the dispensers.

17. A method for three-dimensional (3D) printing comprising:
photopolymerizing a photocurable resin to form a fabricated structure; and
programmed thermal treating of the fabricated structure for transesterification of material of the fabricated structure.

18. The method in accordance with claim 17 wherein the photopolymerizing step comprises photopolymerizing 3D printing reprocessable thermosets to form the fabricated structure.

19. The method in accordance with claim 17 wherein the photopolymerizing step comprises applying patterned ultraviolet (UV) radiation to a UV curable thermoset layer-by-layer to 3D print the fabricated structure.

20. The method in accordance with claim 17 wherein the programmed thermal treatment step comprises heating the fabricated structure at a predetermined temperature for a predetermined time duration for transesterification of material of the fabricated structure.

21. The method in accordance with claim 20 wherein the predetermined temperature is 180° C.

22. The method in accordance with claim 20 wherein the predetermined time duration is greater than four hours.

23. The method in accordance with claim 17 wherein the photocurable resin is a UV curable recyclable thermoset.

24. The method in accordance with claim 17 further comprising:
polishing a damage site on the fabricated structure after it is damaged until a surface at the damage site is flat;
3D printing new material on the flat surface at the damage site by repeating the photopolymerizing to reform a missing portion of the fabricated structure; and
programmed thermal treatment of the fabricated structure including the reformed missing portion.
